(19) United States
(12) Patent Application Publication
(10) Pub. No.: US 2017/0339251 A1
(43) Pub. Date: Nov. 23, 2017

(54) SUPPORTING INTEROPERABILITY IN CLOUD ENVIRONMENTS

(71) Applicant: HEWLETT PACKARD ENTERPRISE DEVELOPMENT LP, Houston, TX (US)

(72) Inventors: Kishore JAGANNATH, Bangalore (IN); Santhosh SRINIVAS, Bangalore (IN); Milan CIPCALA, Prague (CZ)

(73) Assignee: HEWLETT PACKARD ENTERPRISE DEVELOPMENT LP, Houston, TX (US)

(21) Appl. No.: 15/532,467

(22) PCT Filed: Jan. 6, 2015
(86) PCT No.: PCT/US2015/010315

§ 371 Date: Jun. 1, 2017

(51) Int. Cl. H04L 29/08; G06F 9/445; H04L 12/24; H04L 29/06

(52) U.S. Cl. CPC H04L 67/34; H04L 69/08; H04L 67/10; G06F 8/60; H04L 41/0246; H04L 41/12

(57) ABSTRACT

Examples relate to supporting interoperability in cloud environments. In some examples, an application topology is converted to a cloud product topology that supports a cloud product standard, where the application topology includes a general application and supports a cloud industry standard. Artifacts associated with the general application are imported into a product database, where the artifacts are exposed in the product database via a standard Internet protocol. At this stage, the cloud product topology is imported into the product database to obtain an imported topology, and the general application is deployed from the imported topology to a server computing device that supports the cloud product standard, where the general application accesses the artifacts via the standard Internet protocol after deployment.

### BACKGROUND

Cloud computing offers a compelling cost-effective model for businesses that wish to host their applications and services in an environment that can scale to meet their customer demands while reducing their need in maintaining the overhead of large datacenters and their operations. Cloud computing allows for large groups of remote servers to share centralized data storage and other resources. From the user's perspective, cloud computing is capable of providing identical functionality from any location or computing device.

### BRIEF DESCRIPTION OF THE DRAWINGS

The following detailed description references the drawings, wherein:

FIG. 1 is a block diagram of an example system for supporting interoperability in cloud environments;

FIG. 2 is a block diagram of an example computing device in communication with a server computing device and cloud products for supporting interoperability in cloud environments;

FIG. 3 is a flowchart of an example method for execution by a computing device for supporting interoperability in cloud environments; and

FIG. 4 is a flowchart of an example workflow showing the transformation of a user application to support interoperability in cloud environments.

### DETAILED DESCRIPTION

As detailed above, cloud products enables users to access content and services at a remote location(s) from multiple and various user devices. For example, a cloud storage service may enable a user to upload his files to a cloud repository that is accessible via the Internet from all the user's compatible devices. In this example, the user may use different cloud services to store and access his content. However, a major concern when migrating applications to the cloud is vendor lock-in. Specifically, there is concern that once a cloud product is chosen for deployment and hosting, it will be difficult to migrate the applications to another cloud product belonging to a different provider.

Cloud standards such as Topology and Orchestration Service for Cloud Applications (TOSCA) is emerging as to describe Information Technology (IT) services that go beyond Infrastructure as a Service, by describing the complete application stack and connecting applications to the resource abstraction layer. By supporting and consuming a common standard, enterprises can migrate their applications existing in different cloud product to other cloud products that are capable of modelling and deploying applications.

Examples disclosed herein support interoperability in cloud environments. For example, in some examples, an application topology is converted to a cloud product topology that supports a cloud product standard, where the application topology includes a general application and supports a cloud industry standard. The application topology includes the general application as well as components for deploying the general application. Artifacts associated with the general application are imported into a product database, where the artifacts are exposed in the product database via a standard Internet protocol. At this stage, the cloud product topology is imported into the product database to obtain an imported topology, and the general application is deployed from the imported topology to a server computing device that supports the cloud product standard, where the general application accesses the artifacts via the standard Internet protocol after deployment.

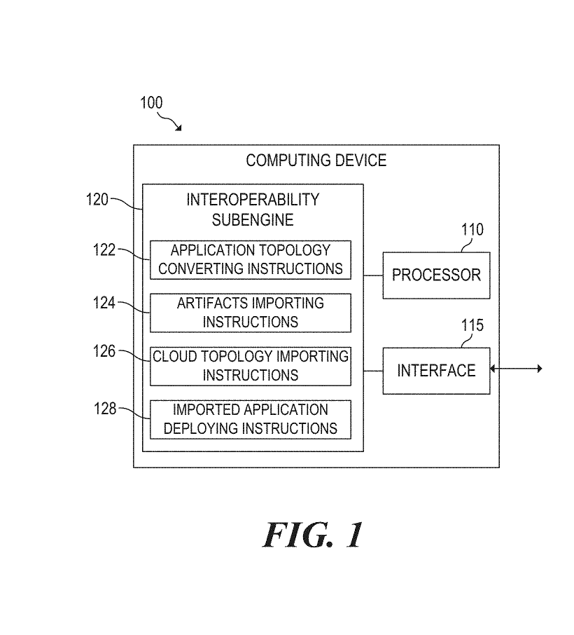

Referring now to the drawings, FIG. 1 is a block diagram of an example system for supporting interoperability in cloud environments. The example system can be implemented as, for example, a computing device 100 such as a notebook computer, a desktop computer, a server computing device, an all-in-one system, a tablet computing device, or any other electronic device suitable for supporting interoperability in cloud environments. In the embodiment of FIG. 1, computing device 100 includes a processor 110, an interface 115, and a machine-readable storage medium 120.

Processor 110 may be one or more central processing units (CPUs), microprocessors, and/or other hardware devices suitable for retrieval and execution of instructions stored in machine-readable storage medium 120. Processor 110 may fetch, decode, and execute instructions 122, 124, 126, 128 to enable supporting interoperability in cloud environments, as described below. As an alternative or in addition to retrieving and executing instructions, processor 110 may include one or more electronic circuits comprising a number of electronic components for performing the functionality of one or more of instructions 122, 124, 126, 128.

Interface 115 may include a number of electronic components for communicating with web service(s) and cloud service(s). For example, interface 115 may be an Ethernet interface, a Universal Serial Bus (USB) interface, an IEEE 1394 (Firewire) interface, an external Serial Advanced Technology Attachment (eSATA) interface, or any other physical connection interface suitable for communication with the cloud product(s) and server computing device(s). Alternatively, interface 115 may be a wireless interface, such as a wireless local area network (WLAN) interface or a near-field communication (NFC) interface. In operation, as detailed below, interface 115 may be used to send and receive data, such as cloud content, cloud content metadata, and cloud content credentials, to and from a corresponding interface of a cloud product or server computing device.

Machine-readable storage medium 120 may be any electronic, magnetic, optical, or other physical storage device that stores executable instructions. Thus, machine-readable storage medium 120 may be, for example, Random Access Memory (RAM), an Electrically-Erasable Programmable Read-Only Memory (EEPROM), a storage drive, an optical disc, and the like. As described in detail below, machine-readable storage medium 120 may be encoded with executable instructions for supporting interoperability in cloud environments.

Application topology converting instructions 122 may convert application topologies to a cloud product topology that supports a cloud product standard. An application topology includes a general application that supports a cloud industry standard. The application topology can also include one or more of the following:
Infrastructure along with the infrastructure components/tiers. For example, the infrastructure can include virtual machine (VM) instances with specific configuration properties on which the application layers will be deployed.
Relationships between the various components of the general application. For example, relationship could exist within application layers or services or between an application and infrastructure component. For example, the web layer of the general application can have a dependency on a database layer because it connects to a database. Also the web layer could be hosted on an infrastructure tier (i.e., web layer hosted on a VM instance).
Application specific artifacts such as those described below with respect to instructions 126. Such artifacts should be transferred into the target server instance in a specific location (e.g., Tomcat webapp directory).
Scripts for deploying applications and provisioning the infrastructure. Such scripts contain the execution logic for performing deployment.
Application and infrastructure component properties such as port no, db user, operating system, VM memory, etc.

A cloud industry standard (e.g., TOSCA) allows for characteristics such as application deployment and infrastructure provisioning to be expressed in a standard format. TOSCA, in particular, aims to address standards at a complete application level (i.e., platform as a service (PaaS) and infrastructure as a service (IaaS)). Any cloud industry standard along the lines of TOSCA should be able to represent the complete application model, the prerequisite infrastructure and software, and procedures for deploying the application.

Each cloud product has a cloud product topology that supports a corresponding cloud product standard. A cloud product provides architecture (i.e., hardware, software, management utilities, etc.) for facilitating deployment of general applications to a cloud environment. Examples of cloud products include HP® Continuous Delivery Automation (CDA) and HP® Cloud Service Automation (CSA). The cloud product topology describes how an application should be deployed in its cloud product. Each cloud product can offer differentiating features as part of their cloud topology and deployment process. The corresponding product standard describes the rules (e.g., formatting) that should be used to create a cloud topology for the cloud product. HP® is a registered trademark of Hewlett-Packard Company, which is headquartered in Palo Alto, Calif.

Artifacts importing instructions 124 imports artifacts and scripts into an infrastructure that is accessible by cloud deployments. Artifacts include packaged modules such as dynamic linked libraries (DLL), enterprise archives (EAR), web modules (WAR), etc. that can include descriptors that describe how to deploy the packaged modules. For example, TOSCA includes a cloud service archive (CSAR) depicting the application components, infrastructure components, relationships and deployment logic. TOSCA also contains application artifacts and script files (containing the application deployment logic) as part of the CSAR file, which are imported by artifacts importing instructions. In this example, artifacts and deployment scripts may be imported into a standard data store location (DSL) from where the cloud product can retrieve the artifacts/scripts via standard protocols like file transfer protocol (FTP), hypertext transfer protocol (HTTP), etc. The artifact and deployment scripts location uniform resource identifier (URI) can be configured within the cloud product so that the product is able to retrieve the artifacts during deployment of the general application.

Cloud topology importing instructions 126 imports the cloud product topology into a product database. The imported cloud product topology includes the general application and corresponding deployment scripts that are compatible with the cloud product standard. These product specific model files (e.g., extensible markup language (XML), JavaScript object notation (JSON), etc.) can then be imported into the cloud product via representation state transfer (REST) application program interfaces (APIs). For example, the cloud product may expose a series of REST APIs that have the capability to import various aspects of the general application and store them in a product database as a product specific application model.

Imported application deploying instructions 128 deploy the general application from the imported topology to a server computing device. Specifically, deployment scripts in the product database can be executed to deploy the general application from the imported topology. The deployed application can access the artifacts that were imported by artifacts importing instructions 124. In this manner, the general application can be deployed to various cloud products by converting the general application to the appropriate cloud product topology as described above.

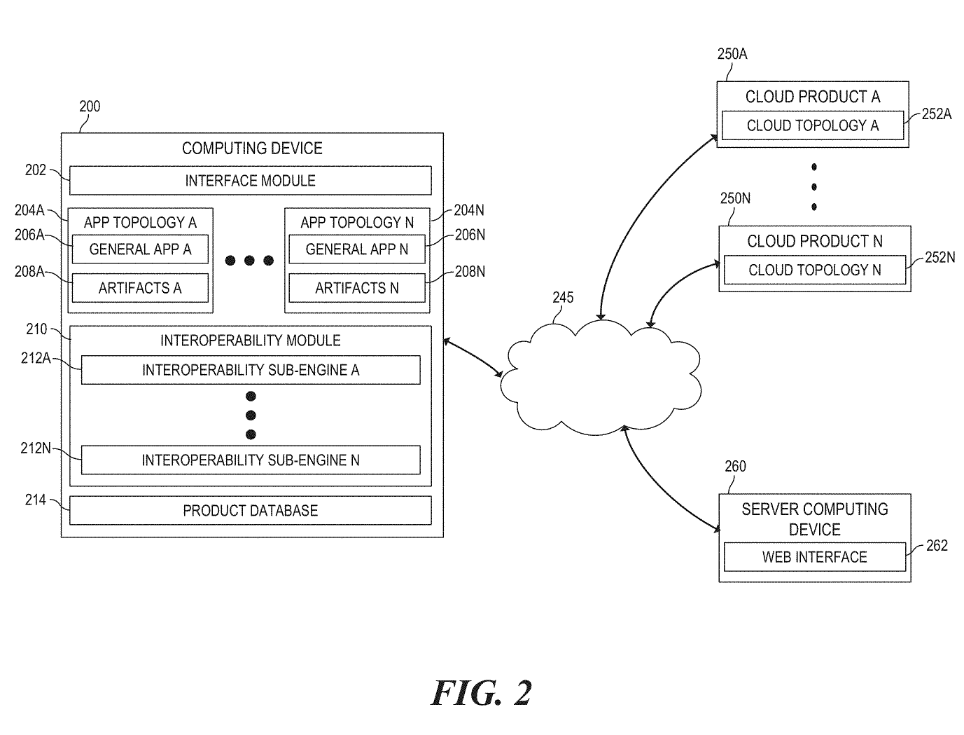

FIG. 2 is a block diagram of an example computing device 200 in communication with a server computing device 260 and cloud products 250A, 250N for supporting interoperability in cloud environments. As illustrated, computing device 200 may include a number of modules 202-214. Each of the modules may include a series of instructions encoded on a machine-readable storage medium and executable by a processor of computing device 200. In addition or as an alternative, each module may include one or more hardware devices including electronic circuitry for implementing the functionality described below.

Interface module 202 may manage communications with cloud products 260A, 260N and server computing device 250. Specifically, the interface module 202 may initiate connections with cloud products 260A, 260N and server computing device 250 and then send or receive cloud data to cloud products 260A, 260N and server computing device 250.

Application topologies 204A, 204N are general application topologies that each include a general application 206A, 206N and associated artifacts 208A, 208N, respectively. Each application topology 204A, 204N includes a deployment script for deploying the corresponding general application 206A, 206N, where the deployment script supports a cloud industry standard (e.g., TOSCA). The associated artifacts 208A, 208N are packages that can come in various forms such as DLL's, EAR, WAR, etc. In other words, each application topology 204A, 204N allows for the deployment of a general application 206A, 206N and its associated artifacts 208A, 208N (i.e., dependencies).

Interoperability module 210 is configured to convert application topologies 204A, 204N to cloud product topologies 252A, 252N. Interoperability module 210 includes numerous interoperability sub-engines 212A, 212N, which each are configured to convert application topologies 204A, 204N to a corresponding cloud product topology 252A, 252N. Specifically, each interoperability sub-engine 212A, 212N is configured to convert application topologies that support a cloud industry standard to a cloud product topology 252A, 252N that supports a cloud product standard. For example, an application topology A 204A that supports TOSCA can be converted to a cloud product topology A 252A that supports CDA topology, and the associated artifacts A 208A can be imported into a standard DSL. In this example, the converted cloud product topology A 252A is configured to be deployed to a server computing device 260 that is configured with CDA. Further, other application topologies N 204N that support other cloud product standards can also be converted for deployment to a server computing device 260 that is configured with CDA.

Product database 214 is configured to store imported artifacts and converted cloud product topologies 252A, 252N. Product database 214 may be implemented on one or more hard disk drives, solid state drives, tape drives, and/or any other storage devices. The storage may be located in computing device 200 and/or in another device in communication with computing device 200.

As shown, computing device 200 may interact with a number of cloud products 250A, 250N. Each of the cloud products 250A, 250N may provide a different cloud product that is accessible to computing device 200. Further, the cloud products 250A, 250N may manage various cloud product topologies 252A, 252N that can be used to deploy general applications 206A, 206N to server computing device 260. Each of the cloud products 250A, 250N may include API or other interface for providing access to the cloud product topologies 252A, 252N to computing device 200.

Server computing device 260 may be a server rack, distributed system, server, server farm, or any other electronic device suitable for providing general applications 206A, 206N in a cloud environment.

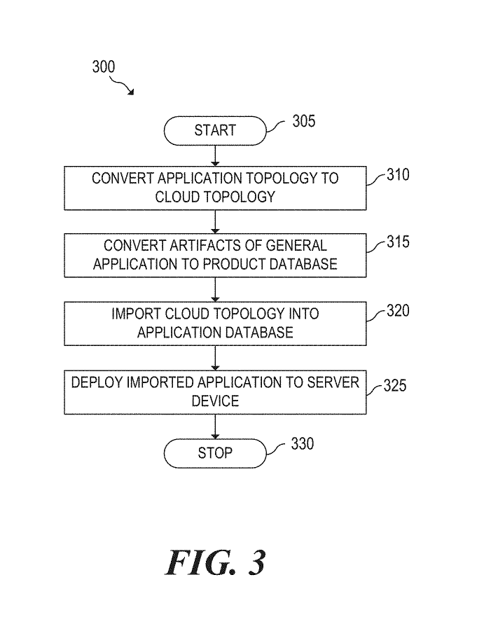

FIG. 3 is a flowchart of an example method 300 for execution by a computing device 100 for supporting interoperability in cloud environments. Although execution of method 300 is described below with reference to computing device 100 of FIG. 1, other suitable devices for execution of method 300 may be used, such as computing device 200 of FIG. 2. Method 300 may be implemented in the form of executable instructions stored on a machine-readable storage medium, such as storage medium 120, and/or in the form of electronic circuitry.

Method 300 may start in block 305 and continue to block 310, where computing device 100 converts application topologies to a cloud product topology that supports a cloud product standard. Each application topology may support a different cloud industry standard. In block 315, artifacts and scripts are imported into an infrastructure that is accessible by cloud deployments.

In block 320, the cloud product topology is imported into a product database. The imported cloud product topology includes the general application and corresponding deployment scripts that are compatible with the cloud product standard. In block 325, the general application is deployed from the imported cloud product topology to a server computing device. Specifically, deployment scripts in the product database can be executed to deploy the general application from the imported topology to the server computing device. Method 300 may then continue to block 330, where method 300 may stop.

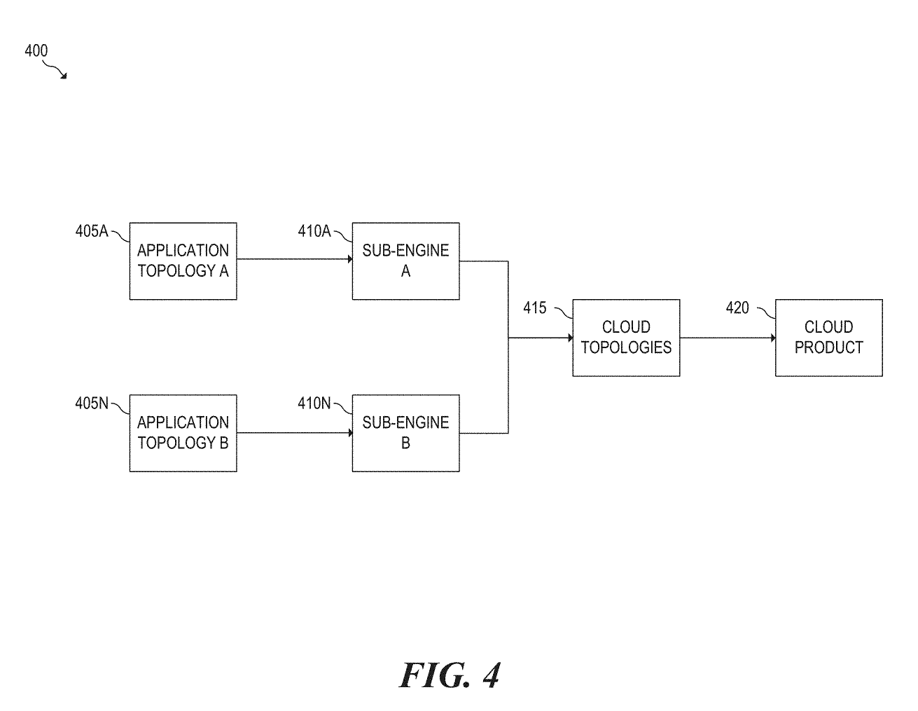

FIG. 4 is a flowchart of an example workflow 400 showing the transformation of a user application to support interoperability in cloud environments. Workflow 400 may be implemented on any number of computing devices.

Cloud product 420 has multiple interoperability sub-engines 410A, 410N. Sub-engine A 410A is configured to process application topology A 405A, which supports a cloud industry standard. Sub-engine N 410N is configured to process application topology N 405N, which supports a different cloud industry standard. In the workflow 410, the sub-engines 410A, 410N convert their respective application topologies 405A, 405N to cloud topologies 415 that support a cloud product standard. After all the application topologies 405A, 405N are converted, the cloud topologies 415 can be deployed to a server computing device that implements the cloud product 420.

The foregoing disclosure describes a number of examples for supporting interoperability in cloud environments. In this manner, the examples disclosed herein enable interoperability in cloud environments by using interoperability sub-engines that are each configured to convert general application topologies to a cloud product topology for deploying to a cloud product.

We claim:

1. A system for supporting interoperability in cloud environments, the system comprising:
an application topology including a general application, wherein the application topology supports a cloud industry standard;
a processor configured to execute an interoperability sub-engine to:
convert the application topology to a cloud product topology that supports a cloud product standard;
import a plurality of artifacts associated with the general application into a product database, wherein the plurality of artifacts are exposed in the product database via a standard Internet protocol;
import the cloud product topology into the product database to obtain an imported topology; and
deploy the general application from the imported topology to a server computing device that supports the cloud product standard, wherein the general application accesses the plurality of artifacts via the standard Internet protocol after deployment.

2. The system of claim 1, wherein the interoperability sub-engine is one of a plurality of interoperability sub-engines for execution by the processor, and wherein each of the plurality of interoperability sub-engines is associated with one of a plurality of general applications.

3. The system of claim 1, wherein the processor is configured to execute a second interoperability sub-engine to:
convert a second application topology to a second cloud product topology that supports the cloud product standard, wherein the second application topology includes a second general application and supports a second cloud industry standard; and
import a second plurality of artifacts associated with the second general application into the product database, wherein the second plurality of artifacts are exposed in the product database via the standard Internet protocol.

4. The system of claim 1, wherein converting the application topology comprises converting a deployment script that supports the cloud industry standard to a converted deployment script that supports the cloud product standard.

5. The system of claim 1, wherein the cloud product topology is imported into the product database using a representation state transfer (REST) application program interface (API).

6. The system of claim 1, wherein the cloud industry standard is Topology and Orchestration Service for Cloud Applications.

7. A method for supporting interoperability in cloud environments, the method comprising:
converting an application topology to a cloud product topology that supports a cloud product standard, wherein the application topology includes a general application and supports a cloud industry standard;
importing a plurality of artifacts associated with the general application into a product database, wherein the plurality of artifacts are exposed in the product database via a standard Internet protocol;
using a representation state transfer (REST) application program interface (API) to import the cloud product topology into the product database to obtain an imported topology; and
deploying the imported topology to a server computing device that supports the cloud product standard, wherein the general application accesses the plurality of artifacts via the standard Internet protocol after deployment.

8. The method of claim 7, wherein each of a plurality of application topologies are converted and imported into the product database.

9. The method of claim 7, further comprising:
converting a second application topology to a second cloud product topology that supports the cloud product standard, wherein the second application topology includes a second general application and supports a second cloud industry standard; and
importing a second plurality of artifacts associated with the second general application into the product database, wherein the second plurality of artifacts are exposed in the product database via the standard Internet protocol.

10. The method of claim 7, wherein converting the application topology comprises converting a deployment script that supports the cloud industry standard to a converted deployment script that supports the cloud product standard.

11. The method of claim 7, wherein the cloud industry standard is Topology and Orchestration Service for Cloud Applications.

12. A non-transitory machine-readable storage medium encoded with instructions executable by a processor for supporting interoperability in cloud environments, the machine-readable storage medium comprising instructions to:
convert an application topology to a cloud product topology that supports a cloud product standard, wherein the application topology includes a general application and supports a cloud industry standard, and wherein converting the application topology comprises converting a deployment script that supports the cloud industry standard to a converted deployment script that supports the cloud product standard;
import a plurality of artifacts associated with the general application into a product database, wherein the plurality of artifacts are exposed in the product database via a standard Internet protocol;
import the cloud product topology into the product database to obtain an imported topology; and
deploy the imported topology to a server computing device that supports the cloud product standard, wherein the general application accesses the plurality of artifacts via the standard Internet protocol after deployment.

13. The non-transitory machine-readable storage medium of claim 12, wherein each of a plurality of application topologies are converted and imported into the product database.

14. The non-transitory machine-readable storage medium of claim 12, wherein the instructions are further to:
convert a second application topology to a second cloud product topology that supports the cloud product standard, wherein the second application topology includes a second general application and supports a second cloud industry standard; and
import a second plurality of artifacts associated with the second general application into the product database, wherein the second plurality of artifacts are exposed in the product database via the standard Internet protocol.

15. The non-transitory machine-readable storage medium of claim 12, wherein the cloud product topology is imported into the product database using a representation state transfer (REST) application program interface (API).
